(19) United States
(12) Patent Application Publication
(10) Pub. No.: US 2017/0351084 A1
(43) Pub. Date: Dec. 7, 2017

(54) ANGLED MIRROR

(71) Applicant: GUS PERISCOPES GMBH & CO. KG, Luebbecke (DE)

(72) Inventors: OLAF KRAETZIG, ROEDINGHAUSEN (DE); WLADISLAW FRIBUS, ESPELKAMP (DE)

(21) Appl. No.: 15/611,990

(22) Filed: Jun. 2, 2017

(30) Foreign Application Priority Data
Jun. 2, 2016 (DE) 20 2016 102 941

(51) Int. Cl. G02B 23/08; G02B 1/14; F41H 5/26; G02B 1/02

(52) U.S. Cl. CPC G02B 23/08; G02B 1/02; G02B 1/14; F41H 5/266

(57) ABSTRACT

An angled mirror for an armored vehicle includes a housing having a lower look-in window or aperture, an upper look-out window or aperture and a one-part or multipart prism located in the housing. The prism has an outside view surface which remains permanently functional in strongly sandy surroundings due to a layer made of transparent ceramic that is disposed in the look-out window or aperture.

### CROSS-REFERENCE TO RELATED APPLICATION

This application claims the priority, under 35 U.S.C. §119, of German Application DE 20 2016 102 941, filed Jun. 2, 2016; the prior application is herewith incorporated by reference in its entirety.

### BACKGROUND OF THE INVENTION

### Field of the Invention

The invention relates to an angled mirror for an armored vehicle, including a housing having a lower look-in window or aperture, an upper look-out window or aperture and a one-part or multipart prism located in the housing and having an outside view surface.

Such an angled mirror for armored vehicles, which is known from German Application DE 28 10 206 A1, is equipped with a silicate glass pane in front of the outside view surface of the prism.

The known angled mirror has the disadvantage that such a silicate glass pane can be ground into a matte finish upon the use of a vehicle equipped therewith in desert regions over the long term by fine sand particles, for example from dust trails of preceding vehicles, so that the angled mirror rapidly becomes unusable and the vehicles equipped therewith can no longer be moved safely.

### SUMMARY OF THE INVENTION

It is accordingly an object of the invention to provide an angled mirror, which overcomes the hereinafore-mentioned disadvantages of the heretofore-known mirrors of this general type and which remains permanently functional even in strongly sandy surroundings.

With the foregoing and other objects in view there is provided, in accordance with the invention, an angled mirror for an armored vehicle, including a housing having a lower look-in window or aperture, an upper look-out window or aperture and a one-part or multipart prism located in the housing and having an outside view surface. A layer of transparent, in particular glass-clear transparent ceramic, is disposed in the look-out window or aperture.

Such a transparent ceramic has, in addition to a high relative transparency, hardness and strength which are multiple times higher than typical silicate glass panes, as well as a very high thermal load-bearing capacity and chemical resistance and a weight which is approximately 30% lighter than armored glass.

Through the use of such a layer made of transparent ceramic, the angled mirror may thus be outstandingly protected from abrasion, and it is also advantageous that due to the high hardness and strength, the structure of the angled mirror located behind it is protected very well against impacts and other mechanical effects. Transparent ceramic has proven to be a material which is extremely robust for rough surroundings, so that the layer made of transparent ceramic disposed in the look-out window represents an outstandingly wear-resistant pane, which substantially lengthens the service life of an angled mirror equipped therewith. A further special advantage is that cracks, in contrast to silicate glass, do not propagate in this material, so that the transparency is also substantially maintained in the event of partial damage to the angled mirror.

Such a layer can be formed, for example, of a single ceramic tile or of multiple ceramic tiles disposed adjacent one another, wherein possible joints between multiple ceramic tiles and seams can be constructed to be completely invisible by using an advantageous adhesive technology. The layer made of transparent ceramic is particularly preferably used as the outermost layer of layers disposed on the outside view surface of the prism, so that layers located underneath are substantially protected from impacts and completely protected from abrasion. Such further layers can be radiation protection layers or also pane heaters, wherein these layers can be applied by using a transparent adhesive film or a transparent adhesive to the outside view surface of the prism or to further functional layers.

According to another advantageous embodiment of the invention, the layer made of transparent ceramic is fixed and spaced apart from the prism in the housing thereof, so that it is also possible by simply replacing the upper housing half to retrofit already installed angled mirrors with a wear-resistant pane in the look-out window.

The layer made of transparent ceramic is substantially formed of aluminum oxide, such as Al₂O₃, or of a magnesium aluminate, such as MgAl₂O₄ (spinel). This material is accompanied by the further advantage of being infrared-transmissive and, in the case of an embodiment made of a sintered corundum, furthermore also has no tendency toward crack propagation after damage, so that after damage, the function of the angled mirror adjacent the damage is still maintained.

In one preferred embodiment of the angled mirror according to the invention, behind the layer made of transparent ceramic, a camera optical unit of a digital camera or a night vision or thermal imaging camera is additionally disposed in a recess in the prism or adjacent, above, or in front thereof in the housing of the angled mirror. Such a layer is also transmissive to thermal radiation, on one hand, and the camera optical unit can thus be disposed so it is outstandingly protected, on the other hand.

Other features which are considered as characteristic for the invention are set forth in the appended claims.

Although the invention is illustrated and described herein as embodied in an angled mirror, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, partially sectional, front-elevational view of an angled mirror; and

FIG. 2 is a partially sectional, side-elevational view of the angled mirror according to FIG. 1.

### DETAILED DESCRIPTION OF THE INVENTION

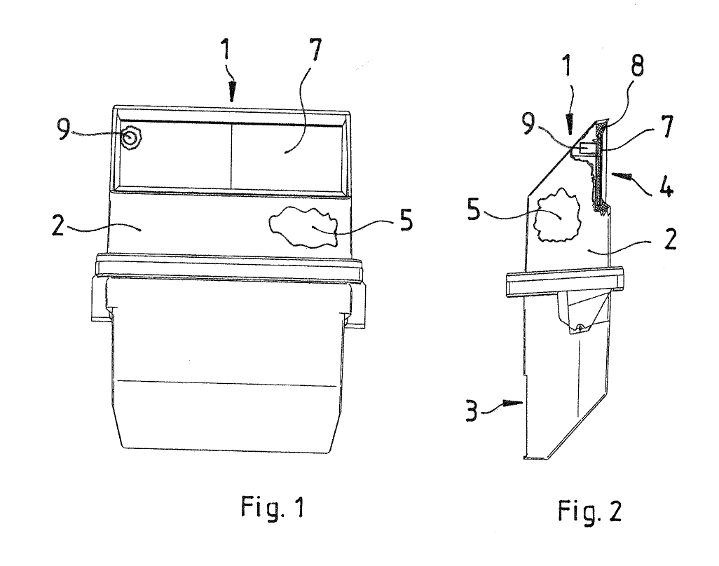

Referring now to the figures of the drawings as a whole, there is seen an angled mirror or corner reflector or periscope 1 for an armored vehicle which is formed of a housing 2 including a lower look-in window or aperture 3, an upper look-out window or aperture 4, and a one-part or multipart prism 5 located therein having an outside view surface 8, in front of which a layer 7 made of transparent ceramic is disposed. As shown in FIG. 1, the layer 7 is formed of two ceramic tiles disposed adjacent one another. A camera optical unit 9 of a digital camera or a night vision or thermal imaging camera is disposed behind the layer 7 of transparent ceramic in a recess formed in the prism 5 or adjacent the prism 5 in the housing 2.

A configuration of one-part layers 7 or of multiple layers 7 disposed in succession and made of transparent ceramic is also possible, but is not shown in the drawing.

The layer 7 made of transparent ceramic is disposed directly on the outside view surface 8 of the prism 5 and a connection therebetween can be produced by using a transparent adhesive film or a transparent adhesive directly on the prism 5 or on further interposed functional layers, which is also not shown in the drawing, however.

A layer 7 which is fixed so as to be spaced apart from the prism 5 separately in the housing 1, is also not shown in the drawing.

The layer 7 made of transparent ceramic is formed, for example, of aluminum oxide, such as Al₂O₃, or of a magnesium aluminate, such as MgAl₂O₄.

1. An angled mirror for an armored vehicle, the angled mirror comprising:
a housing including a lower look-in window and an upper look-out window;
a one-part or multipart prism located in said housing, said prism having an outside view surface; and
a layer of transparent ceramic disposed in said look-out window.

2. The angled mirror according to claim 1, wherein said layer is formed of a ceramic tile or multiple ceramic tiles disposed adjacent one another.

3. The angled mirror according to claim 1, wherein said layer is an outermost layer of a plurality of layers disposed on said outside view surface of said prism.

4. The angled mirror according to claim 3, which further comprises a transparent adhesive film or a transparent adhesive mounting said layer to said outside view surface of said prism or to further functional layers applied on said outside view surface of said prism.

5. The angled mirror according to claim 1, wherein said layer is fixed in a position spaced apart from said prism in said housing.

6. The angled mirror according to claim 1, wherein said layer is formed of aluminum oxide or a magnesium aluminate.

7. The angled mirror according to claim 1, wherein said layer is formed of Al₂O₃ or MgAl₂O₄ (spinel).

8. The angled mirror according to claim 1, which further comprises a camera optical unit of a digital camera or a night vision or thermal imaging camera disposed behind said layer of transparent ceramic in a recess formed in said prism or adjacent said prism in said housing.
